(19) United States
(12) Patent Application Publication
(10) Pub. No.: US 2013/0263516 A1
(43) Pub. Date: Oct. 10, 2013

(54) DOOR SEAL

(71) Applicant: David Potter, Pleasant View, UT (US)

(72) Inventor: David Potter, Pleasant View, UT (US)

(21) Appl. No.: 13/442,676

(22) Filed: Apr. 9, 2012

(51) Int. Cl. E06B 7/23; E06B 7/16

(52) U.S. Cl. 49/493.1; 49/506

(57) ABSTRACT

For sealing a door, a jamb interface with a specified width connects to a jamb interior face of a jamb along a longitudinal axis of the jamb interior face. A flap forms a seal between a section door and the jamb.

### FIELD

The subject matter disclosed herein relates to seals and more particularly relates to door seals.

### BACKGROUND

### Description of the Related Art

Doors are most energy efficient when the space between a door and a jam or lintel is sealed to prevent air circulation.

### BRIEF SUMMARY

An apparatus for sealing a door is disclosed. A jamb interface with a specified width connects to a jamb interior face of a jamb along a longitudinal axis of the jamb interior face. A flap forms a seal between a section door and the jamb. A method and system also perform the functions of the apparatus.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a front view drawing illustrating one embodiment of a sectional door;

FIG. 2 is a top view drawing illustrating one embodiment of a section and jamb;

FIG. 3 is a top view drawing illustrating one embodiment of a section and jamb with door seal;

FIG. 4 is a perspective view drawing illustrating one embodiment of a door seal;

FIG. 5 is a perspective view drawing illustrating one alternate embodiment of a door seal;

FIG. 6 is a perspective view drawing illustrating one alternate embodiment of a door seal;

FIG. 7 is a perspective view drawing illustrating one alternate embodiment of a door seal;

FIG. 8 is a top view drawing illustrating one embodiment of a door seal;

FIG. 9 is a top view drawing illustrating one alternate embodiment of a door seal;

FIG. 10 is a top view drawing illustrating one alternate embodiment of a door seal; and

FIG. 11 is a schematic flow chart diagram illustrating one embodiment of a door seal method.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

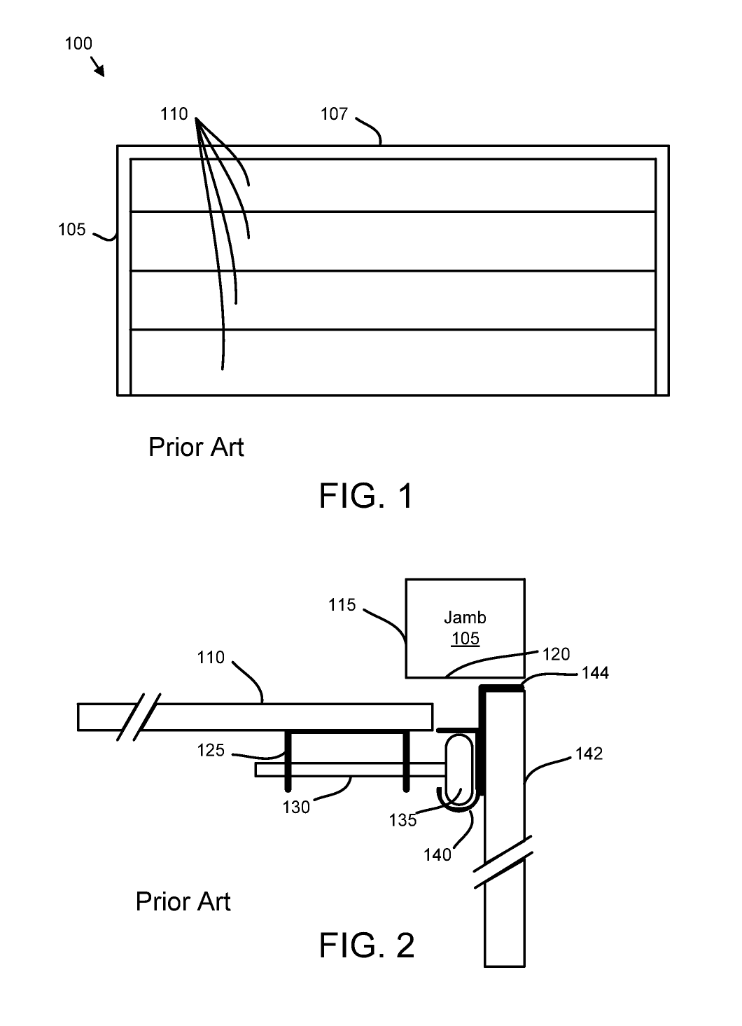

FIG. 1 is a front view drawing illustrating one embodiment of a sectional door 100. The sectional door 100 may be a garage door. The sectional door 100 includes a plurality of sections 110. A jamb 105 and a lintel 107 may be disposed adjacent the sectionals 110.

FIG. 2 is a top view drawing illustrating one embodiment of a section 110 and a jamb 105. The section 110 and the jamb 105 are the section 110 and the jamb 105 of FIG. 1. The section 110 may be connected to a bracket 125. The bracket 125 may secure an axle 130 for a wheel 135. The wheel 135 may move within a track 140. In the depicted embodiment, the track 140 is secured to a horizontal reinforcing angle 142. Alternatively, the track 140 may be secured to a post. In a certain embodiment, the track 140 is secured to the jamb 105 by a jamb angle 144. The sectional door 100 may be opened and closed as the sections 110 are moved along the track 140. The jamb 105 includes a jamb traverse face 115 and a jamb interior face 120.

The embodiments described herein may form a seal between sections 110 of the sectional door 100 and the jamb 105. In addition, the embodiments may form a seal between one or more sections 110 and the lintel 107. For simplicity, both the jamb 105 and the lintel 107 are referred to as the jamb 105. One of skill in the art will recognize that the embodiments may be applied to both the vertical jamb 105 and the horizontal lintel 107.

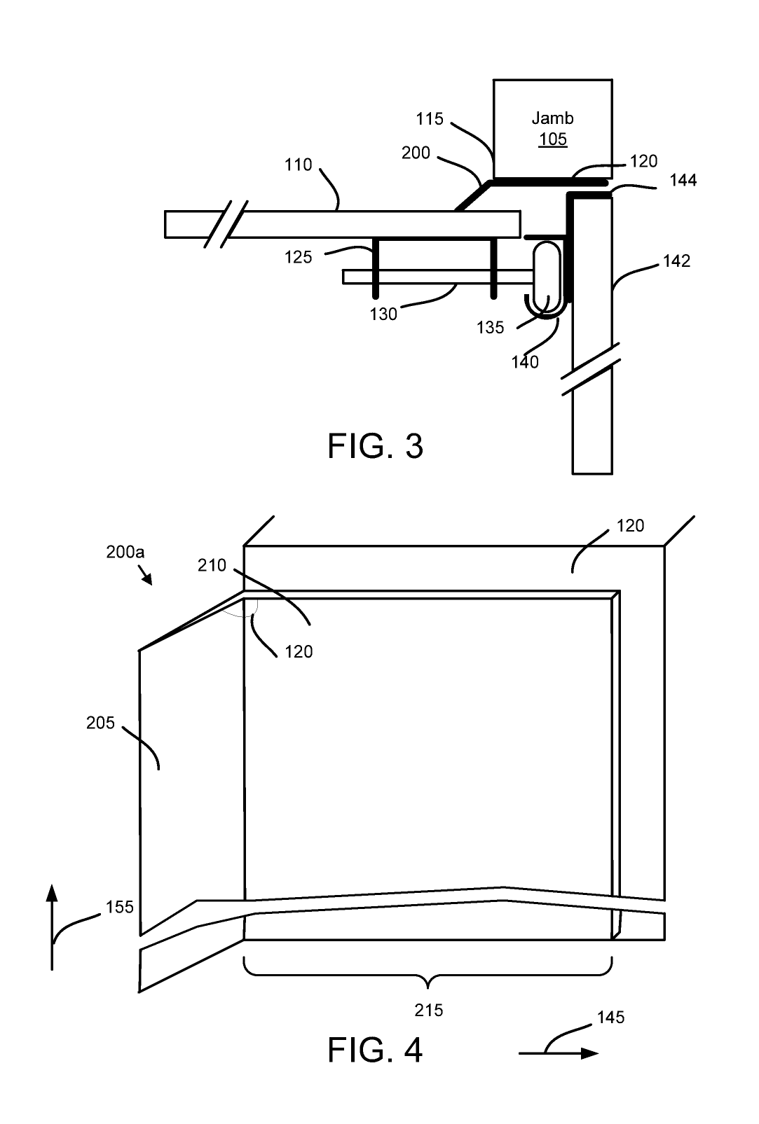

FIG. 3 is a top view drawing illustrating one embodiment of a section 110 and jamb 105 with door seal 200. In the depicted embodiment, the door seal 200 is shown forming a seal between the jamb 105 and the section 110. One of skill in the art will recognize that the door seal 200 may form a seal between multiple sections 110 and the jamb 105. Alternatively, the door seal 200 may form a seal between one or more sections 110 and the lintel 107. The door seal 200 connects to the jamb interior face 120 along a longitudinal axis of the jamb interior face 120.

In addition to forming a seal between the sectional door 100 and the jamb 105, the door seal 200 separates the track 140 from the jamb 105, forming a thermal break between the sectional door 100 and walls connected to the jamb 105.

FIG. 4 is a perspective view drawing illustrating one embodiment of a door seal 200a. The door seal 200a is depicted connected to the jamb interior face 120 along the latitudinal axis 155 of the jamb interior face 120. The door seal 200a includes a jamb interface 210 and a flap 205. The flap 205 and the jamb interface 210 may be formed of an elastomer. In one embodiment, the jamb interface 210 and the flap 205 are extruded as a single piece.

The jamb interface 210 is connected to the jamb interior face 120 along a longitudinal axis 155 of the jamb interior face 120. The jamb interface 210 may be connected with a screw, a nail, a bolt, an adhesive, or the like. The jamb interface 210 may have a specified width 215 along a latitudinal axis 145. In one embodiment, the specified width is in the range of 9 to 14 centimeter (cm). In a certain embodiment, the specified width is in the range of 4 inches to 5.5 inches. In one embodiment, a roughness Ra of the surface of the jamb interface 210 that connects to the jamb interior face 120 is in the range 50,000 to 100,000 microinches.

The flap 205 is disposed at an angle 202 to the jamb interface 210. In one embodiment, the angle 202 is in the range of 110° to 150°. The flap 205 may be flexible. As a result, the flap 205 may bend when the flap 205 contacts the section 110 and forms a seal, increasing the angle 202. By connecting to the jamb interior face 120, the door seal 200a improves the seal between the jamb 105 and the section 110. In addition, the door seal 200a is less susceptible to damage.

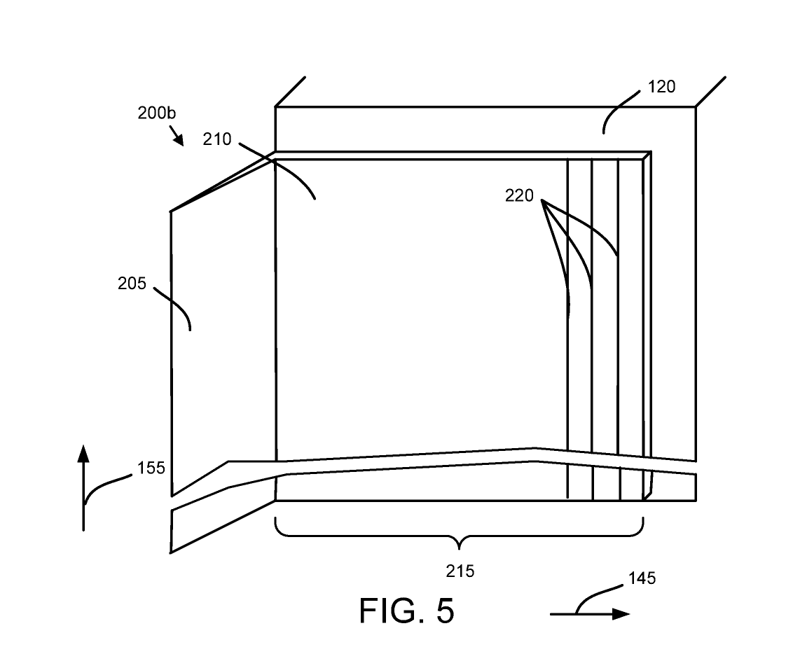

FIG. 5 is a perspective view drawing illustrating one alternate embodiment of a door seal 200b. The door seal 200b is depicted connected to the jamb interior face 120 of FIG. 4. The jamb interface 210 includes a plurality of break grooves 220 disposed longitudinally along the longitudinal axis 155 of the jamb interface 210. In one embodiment, each break grooves 210 is formed as a groove, indentation, score, or the like. The jamb interface 210 may be bent at a break groove 220. Repeatedly bending at the break groove 220 may separate a portion of the jamb interface 210 at the break groove 220.

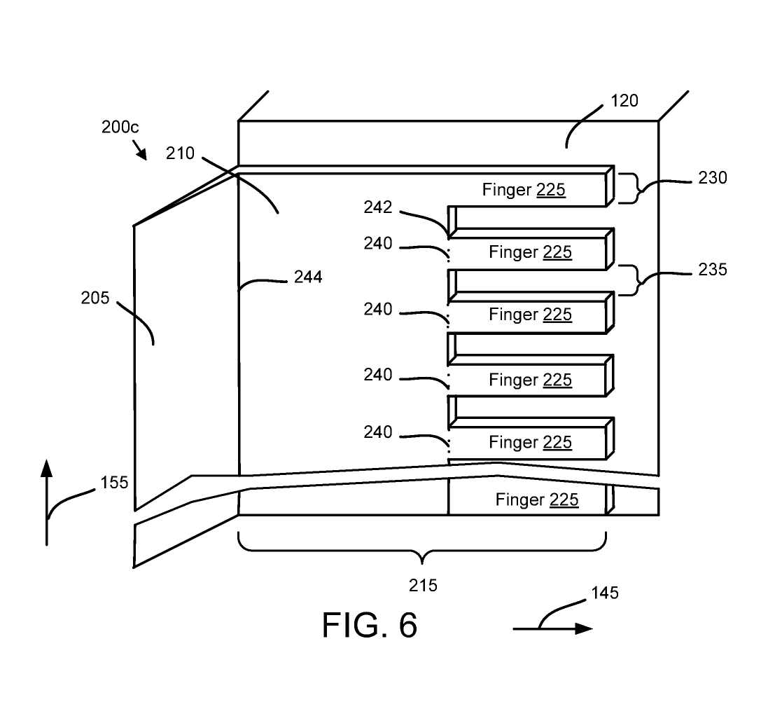

FIG. 6 is a perspective view drawing illustrating one alternate embodiment of a door seal 200c. The door seal 200c is depicted connected to the jamb interior face 120 of FIGS. 4 and 5. A plurality of fingers 225 are formed in the jamb interface 210. Each finger 225 may have a specified finger height 230. In addition, each finger 225 may be separated from adjacent fingers 225 by a specified finger spacing 235. In one embodiment, the specified finger height is in the range of 1 to 1.5 cm and the specified finger spacing is in the range of 1 to 1.5 cm.

A proximal edge 242 of the finger 225 may be in the range of 4 to 6.5 cm along the latitudinal axis 145 from an intersection 244 of the flap 205 and the jamb interface 210. In one embodiment, one or more of the fingers 225 are scored 240 at the proximal edge 242. The scoring 240 may be an indentation, a groove, or the like. The scoring 240 may be to a depth of 1/32 of an inch. In one embodiment, when the finger 225 is bent at the score 240, the finger 225 may be separated from the jamb interface 210.

In one embodiment, the door seal 200c may be positioned so that the fingers 225 avoid obstacles such as screws, nails, wires, and the like. In addition, fasteners such as screws, nails, and the like may be disposed between the fingers 225.

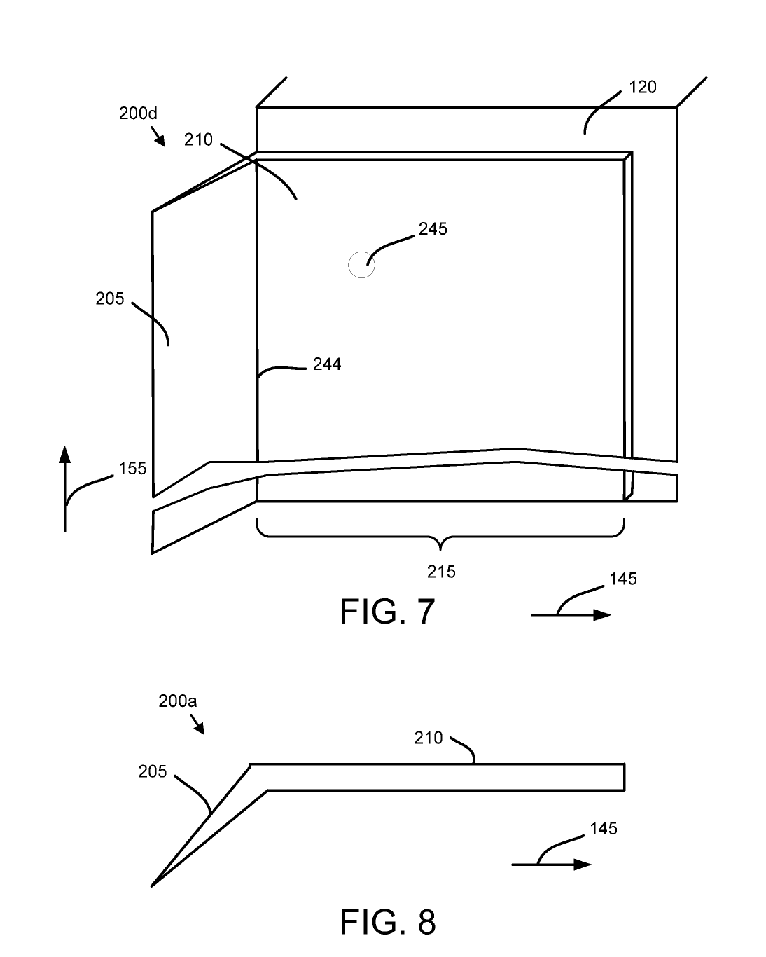

FIG. 7 is a perspective view drawing illustrating one alternate embodiment of a door seal 200d. The door seal 200d is depicted connected to the jamb interior face 120 of FIGS. 4-6. The jamb interface 210 includes a connector hole 245. The connector hole 245 may be disposed in the range of 3.5 to 6.5 cm from the intersection 244 of the flap 205 and the jamb interface 210 along the latitudinal axis 145. In addition, the connector hole 245 may be a ⅛ inch hole.

FIG. 8 is a top view drawing illustrating one embodiment of a door seal 200a. The door seal 200a is the door seal 200a of FIG. 4. The flap 205 and the jamb interface 210 are shown.

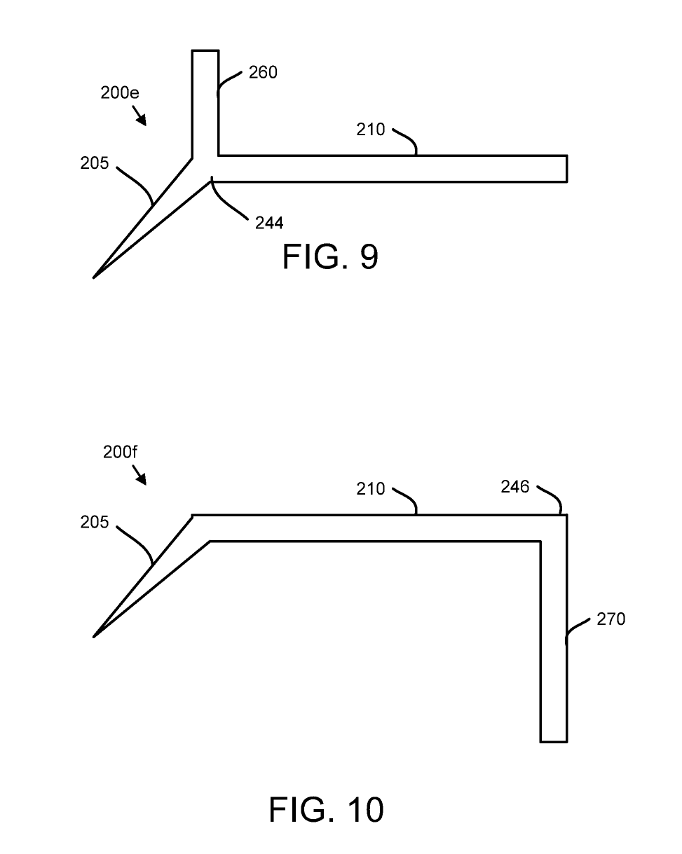

FIG. 9 is a top view drawing illustrating one alternate embodiment of a door seal 200e. The door seal 200e is depicted with a jamb flange 260. The jamb flange 260 is disposed at the intersection 244 of the flap 205 and the jamb interface 210. The jamb flange 260 may be orthogonal to the latitudinal axis 145 and the longitudinal axis 155, and abut the jamb traverse face 115 of the jamb 105. The jamb flange 260 may be extruded as a single piece with the flap 205 and the jamb interface 210. In one embodiment, the jamb flange 260 extends the seal between the section 110 and the jamb 105.

FIG. 10 is a top view drawing illustrating one alternate embodiment of a door seal 200f. The door seal 200f is depicted with a wall flange 270. The wall flange 270 may be disposed at a distal edge 246 of the jamb interface 210. In one embodiment, the wall flange 270 is orthogonal to the latitudinal axis 145 and orthogonal to the longitudinal axis 155 of the jamb interior face 120. In addition, the wall flange 270 may abut the lintel 270.

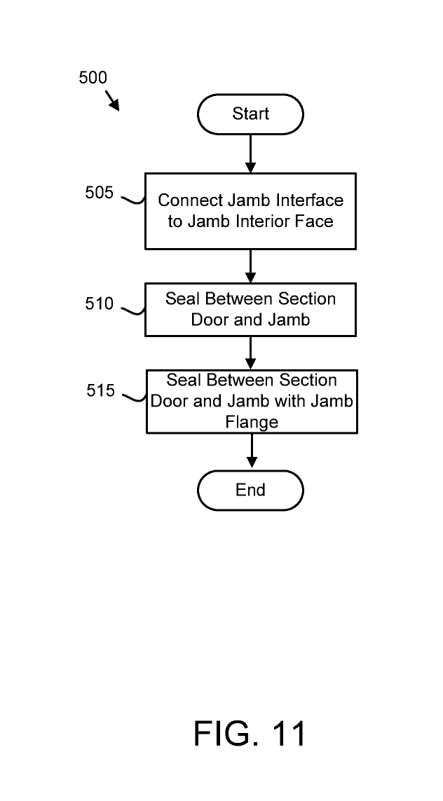

FIG. 11 is a schematic flow chart diagram illustrating one embodiment of a door seal method 500. The method 500 may perform the functions of the door seal 200 of FIGS. 1-10. The method 500 starts, and the jamb interface 210 with the specified width 215 connects 505 to the jamb interior face 120 of the jamb 105 along the longitudinal axis 155 of the jamb interior face 120. The flap 205 seals 510 between the section door 100 and the jamb 105.

In one embodiment, the jamb flange 260 seals 515 between the section door 100 and the jamb 105 and the method 500 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a jamb interface with a specified width connecting to a jamb interior face of a jamb along a longitudinal axis of the jamb interior face; and
a flap forming a seal between a section door and the jamb.

2. The apparatus of claim 1, wherein the specified width is in the range of 9 to 14 centimeter (cm).

3. The apparatus of claim 1, further comprising a jamb flange disposed at an intersection of the flap and the jamb interface, the jamb flange orthogonal to a latitudinal axis and the longitudinal axis of the jamb interior face, and abutting a jamb traverse face of the jamb.

4. The apparatus of claim 1, further comprising a wall flange disposed at a distal edge of the jamb interface, orthogonal to a latitudinal axis and the longitudinal axis of the jamb interior face, and connected to a wall.

5. The apparatus of claim 1, further comprising at least one break groove disposed longitudinally along the jamb interface.

6. The apparatus of claim 1, wherein the flap and the jamb interface are extruded as a single piece.

7. The apparatus of claim 1, wherein the flap and jamb interface are formed of an elastomer.

8. The apparatus of claim 1, the jamb interface further comprising a plurality of fingers, each finger having a specified finger height, and each finger separated from adjacent fingers by a specified finger spacing.

9. The apparatus of claim 8, wherein the specified finger height is in the range of 1 to 1.5 cm and the specified finger spacing is in the range of 1 to 1.5 cm.

10. The apparatus of claim 9, wherein a proximal edge of the plurality of fingers is in the range of 4 to 6.5 cm from an intersection of the flap and the jamb interface.

11. The apparatus of claim 10, wherein the proximal edge of one or more of the plurality of fingers is scored.

12. The apparatus of claim 11, wherein each finger is scored to a depth of 1/32 of an inch.

13. The apparatus of claim 1, the jamb interface further comprising a connector hole.

14. The apparatus of claim 13, wherein the connector hole is disposed in the range of 3.5 to 6.5 cm from an intersection of the flap and the jamb interface and is a ⅛ inch hole.

15. A method for sealing a door comprising:
connecting a jamb interface with a specified width to a jamb interior face of a jamb along a longitudinal axis of the jamb interior face; and
sealing between a section door and the jamb.

16. The method of claim 15, wherein the method further comprises sealing between the section door and the jamb with a jamb flange disposed at an intersection of the flap and the jamb interface, the jamb flange orthogonal to a latitudinal axis and the longitudinal axis of the jamb interior face, and abutting a jamb traverse face of the jamb.

17. The method of claim 15, the jamb interface further comprising a plurality of fingers, each finger having a specified finger height, and each finger separated from adjacent fingers by a specified finger spacing.

18. The method of claim 15, wherein the method further comprising connecting a wall flange to a wall, the wall flange disposed at a distal edge of the jamb interface, orthogonal to a latitudinal axis and the longitudinal axis of the jamb interior face.

19. The method of claim 15, further comprising disposing a connector hole in the range of 3.5 to 6.5 cm from an intersection of the flap and the jamb interface

20. A system comprising:
a section door;
a jamb;
a jamb interface with a specified width connecting to a jamb interior face of the jamb along a longitudinal axis of the jamb interior face; and
a flap forming a seal between the section door and the jamb.
